(19) United States
(12) Patent Application Publication
(10) Pub. No.: US 2010/0257066 A1
(43) Pub. Date: Oct. 7, 2010

(54) ELECTRONIC RECEIPTS COLLECTION AND MANAGEMENT SYSTEM

(75) Inventors: Theresa M. Jones, Charlotte, NC (US); Alicia C. Jones, Fort Mill, SC (US); Keith D. Agisim, Charlotte, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, Charlotte, NC (US)

(21) Appl. No.: 12/418,941

(22) Filed: Apr. 6, 2009

(51) Int. Cl. G06Q 10/00; G06Q 40/00; G06Q 20/00

(52) U.S. Cl. 705/17; 705/21; 705/30

(57) ABSTRACT

Embodiments of the invention relate to apparatuses, methods, and computer program products for collecting and managing receipts arising out of financial transactions. More particularly, embodiments of the present invention relate to apparatuses, methods, and computer program products for collecting electronic receipts by receiving an electronic indication of a transaction between a vendor and a consumer, receiving an electronic indication from the consumer that the consumer desires to have an electronic receipt resulting from the transaction electronically transmitted to a financial institution, and permitting electronic transmission of the electronic receipt to the financial institution.

### FIELD

In general, embodiments of the invention relate to methods and apparatuses for collecting and managing receipts.

### BACKGROUND

Consumers save their receipts after making a purchase for a variety of reasons. Saved receipts may be used by consumers to return merchandise, to track expenses for budgeting purposes, or to substantiate tax, reimbursement, or warranty claims, among many other uses. Currently, consumers collect paper receipts and save and organize them in physical space. For in-store purchases, consumers generally obtain a paper receipt at the point-of-sale. For telephone or online purchases, consumers may wait for a paper receipt to arrive in the mail, or may obtain an electronic receipt that they can print to generate a paper receipt. Some consumers may never print the electronic receipts they obtain, and instead retain those receipts in electronic form, for example, in their email accounts, in which case there is no single repository for all of such consumers' receipts. Therefore, in today's world, consumers may store old receipts in one or more locations, both physical and electronic, and the stored receipts are only as organized as the particular consumer's efforts dictate.

Weeks, months, or even years may pass before a consumer needs to use an old receipt. For example, one consumer may need to submit all receipts associated with business expenses to her employer at the end of a month for reimbursement purposes. Another consumer may need to submit all receipts related to charitable contributions to her accountant at the end of the tax year for income deduction purposes. In either of these instances, or the countless other instances in which a consumer has a need to retrieve old receipts, the consumer must rely on her past diligence in storing and organizing receipts in order to achieve her intended goal. For the average consumer, it is a time-consuming endeavor to locate the particular receipt(s) needed, and it may in fact prove to be impossible. Paper receipts are easily misplaced and difficult to organize—not only do they come in all different shapes and sizes, but they may only be categorized at the highest level in one manner, for example, by date or by subject matter. Indeed, the high-level categorization initially chosen for organizational purposes may not be altered without a great deal of work, which is problematic when a particular receipt would be located most easily through a category other than the one chosen. In sum, it is clear that current methods of saving receipts have numerous limitations. At best, these limitations cost consumers their time and sanity as they wade through old receipts to find what they need; at worst, they cost consumers much more—the inability to obtain a refund, a tax deduction, a reimbursement, etc. Therefore, there remains a need for an improved system for assisting a consumer with the collection, retention, and organization of receipts.

### SUMMARY OF EMBODIMENTS OF THE INVENTION

Embodiments of the invention relate to apparatuses, methods, and computer program products for collecting and managing electronic receipts arising out of financial transactions.

In some embodiments, an apparatus is provided comprising a memory device comprising information about a bank account stored therein, a communication device configured to receive an electronic receipt associated with the bank account, wherein the electronic receipt results from a transaction, and wherein the communication device is configured to receive the electronic receipt from a party involved in the transaction, and a processing device configured to store the electronic receipt in the memory device and associate the electronic receipt in the memory device with the bank account.

In some embodiments, the information about the bank account comprises information regarding whether a person associated with the bank account desires for vendors to send electronic receipts to the apparatus. In some embodiments, the transaction involves the purchase of a product from a vendor, and wherein the party involved in the transaction comprises the vendor. According to some embodiments, the transaction involves a consumer making a transaction with a vendor, and wherein the processing device is configured to use the communication device to request that the vendor receive permission from the consumer to send the electronic receipt to the apparatus. In some embodiments, the transaction involves a consumer, and wherein the processing device is configured to use the communication device to receive permission from the consumer to request the electronic receipt from the party involved in the transaction.

In some embodiments, the transaction involves a consumer, and wherein the processing device is configured to use the communication device to send a request to a consumer computing device inquiring whether the consumer desires for the apparatus to store the electronic receipt in the memory device. In such embodiments, the processing device may be configured to receive an indication from the consumer computing device that the transaction is fraudulent. Indeed, in such embodiments, the information about the bank account may include information about how to contact the consumer computing device.

In some embodiments, the memory device of the apparatus comprises a plurality of electronic receipts stored therein and associated with the bank account, wherein the processing device is configured to use the communication device to communicate information about the plurality of electronic receipts to a user, and wherein the processing device is configured to organize the plurality of receipts by vendor, vendor type, date, product type, or transaction amount.

In some embodiments, the processing device of the apparatus is configured to allow a user to mark the electronic receipt as tax-related, and wherein the processing device is configured to store a tax-related electronic receipt for a predetermined length of time. In some embodiments, the memory device comprises a plurality of electronic receipts stored therein, and wherein the processing device is configured to allow the consumer to grant another party limited access to the plurality of electronic receipts.

According to some embodiments of the present invention an apparatus is provided that is configured for use with a transaction between a vendor and a consumer, where the apparatus comprises a user input device configured to receive an indication from the consumer that the consumer desires an electronic receipt resulting from the transaction be sent to a third party, wherein the third party is a party other than the vendor and the consumer, and a processing device operatively coupled to the user input device and configured to permit a transfer of the electronic receipt from the vendor to the third party based at least partially on the indication received from the consumer. The apparatus may further include a user output device, wherein the processing device is operatively coupled to the user output device and configured to use the user output device to ask the consumer whether the consumer desires for the electronic receipt to be sent to a third party.

In some embodiments, the user output device comprises a display, and wherein the processing device is configured to use the display to ask the consumer to decide between receiving a paper receipt and having the electronic receipt sent to the third party. In some embodiments, the user input device is located at the transaction's point-of-sale. In such embodiments, the user input device may be a user interface of a point-of-sale terminal, and the point-of-sale terminal may be configured to obtain information from a payment device provided by the consumer.

In some embodiments, the third party may be a bank. In some embodiments, the transaction involves a consumer's payment device, and the consumer's payment device is issued by the bank. In some embodiments, the transaction comprises a purchase made by the consumer on behalf of an employer of the consumer, and the third party comprises an accounts payable department of the employer.

According to some embodiments, the user input device is further configured to receive information regarding an account to use during the transaction. In such embodiments, the processing device of the apparatus may be configured to permit a transfer of the electronic receipt from the vendor to a third party associated with the account. In some embodiments, the account may be an account that the consumer has with the vendor. Alternatively, in other embodiments, the account may be a bank account used during the transaction.

In some embodiments the user input device is configured to receive information from the consumer identifying the third party, and the processing device is configured to send the electronic receipt to the third party based at least partially on the information received from the user input device. According to some embodiments, the user input device comprises the user interface of a mobile phone. In some embodiments, the processing device is configured to receive information about the transaction from a bank involved in the transaction. In some embodiments, the processing device is configured to permit a transfer of an electronic receipt from the vendor to the third party by communicating the consumer's indication to the vendor or the third party.

In some embodiments, the apparatus may also include a memory device comprising the electronic receipt stored therein, wherein the processing device is configured to permit a transfer of an electronic receipt from the vendor to the third party by transferring the electronic receipt stored in the memory device to the third party.

According to some embodiments of the present invention, an apparatus is provided comprising a memory device comprising information about an account stored therein, wherein the account is associated with a consumer, and wherein the account comprises information regarding the transfer of electronic receipts associated with the account, a communication device configured to receive information about a financial transaction involving the consumer, and a processing device configured to transfer or request the transfer of an electronic receipt associated with the financial transaction based at least partially on the information stored in the memory device regarding the transfer of electronic receipts associated with the account.

In some embodiments, the financial transaction involves a payment device associated with an issuing bank, and the apparatus is maintained by the issuing bank. In some embodiments, the financial transaction involves a vendor, and the processing device is configured to use the communication device to communicate a request to the vendor to transfer the electronic receipt. In some embodiments, the information regarding the transfer of electronic receipts comprises information regarding where the electronic receipt should be transferred, and the request to the vendor includes a request for the vendor to transfer the electronic receipt to a location based on the information regarding where the electronic receipt should be transferred. In such embodiments, the location may be a location of an entity other than the issuing bank. In some embodiments, the location comprises an accounts payable department of an employer of the consumer.

In some embodiments, the financial transaction involves a vendor, and the processing device is configured to use the communication device to communicate a request to the vendor to transfer the electronic receipt to the apparatus. In such embodiments, the processing device may be configured to receive the electronic receipt from the vendor and use the communication device to transfer the electronic receipt to another entity based at least partially on the information stored in the memory device regarding the transfer of electronic receipts associated with the account. Indeed, in some embodiments, the processing device is configured to receive the electronic receipt from the vendor, store the electronic receipt in the memory device, and associate the electronic receipt with the account.

In some embodiments, the financial transaction involves a vendor, and wherein the apparatus is maintained by the vendor. According to some embodiments, the financial transaction involves a vendor, and the account comprises an account associated with the vendor. Indeed, in some embodiments, the account comprises a preferred consumer account provided to the consumer by the vendor.

In some embodiments, the information regarding the transfer of electronic receipts comprises information about whether the consumer desires to have the electronic receipt transferred. According to some embodiments, the information regarding the transfer of electronic receipts comprises information regarding where the electronic receipt should be transferred.

According to some embodiments of the present invention, a method implemented by a computerized apparatus configured to manage the transfer of a consumer's electronic receipts is provided, where the method comprises receiving an electronic indication of a transaction between a vendor and a consumer, receiving an electronic indication from the consumer that the consumer desires to have an electronic receipt resulting from the transaction electronically transmitted to a financial institution, and permitting electronic transmission of the electronic receipt to the financial institution.

In some embodiments, the computerized apparatus comprises a point-of-sale computer system. In some embodiments, the method further comprises using a user output device of the computerized apparatus to ask the consumer whether the consumer desires to have the electronic receipt electronically transmitted to the financial institution. In such embodiments, permitting electronic transmission of the electronic receipt could comprise electronically transmitting the electronic receipt to the financial institution.

In some embodiments, the computerized apparatus comprises a financial institution computer system. In such embodiments, the method may further comprise using a communication device of the computerized apparatus to send a communication to a consumer computer system inquiring whether the consumer desires to have the electronic receipt electronically transmitted to the financial institution. Indeed, in some embodiments, receiving the electronic indication from the consumer that the consumer desires to have an electronic receipt resulting from the transaction electronically transmitted to the financial institution comprises receiving consumer preferences from a memory device, wherein the consumer preferences comprise the consumer's preferences regarding transmission of electronic receipts. In some embodiments, permitting electronic transmission of the electronic receipt comprises requesting that the vendor transmit the electronic receipt to the financial institution computer system.

In some embodiments, the computerized apparatus comprises a consumer computer system. In such embodiments, receiving the electronic indication of the transaction could comprise receiving a communication from the financial institution. In some embodiments, permitting electronic transmission of the electronic receipt comprises communicating an electronic indication to the financial institution that the consumer desires to have the electronic receipt electronically transmitted to the financial institution. In some embodiments, the financial institution comprises a bank, and the bank maintains a financial account used by the consumer during the transaction.

According to some embodiments, a computer program product configured to manage the transfer of a consumer's electronic receipts is provided, the computer program product comprising a computer-readable medium having computer-readable program instructions stored therein, wherein the computer-readable program instructions comprise first instructions configured to receive an indication of a transaction between a vendor and a consumer, second instructions configured to receive an indication from the consumer that the consumer desires to have an electronic receipt resulting from the transaction electronically transmitted to a financial institution, and third instructions configured to permit electronic transmission of the electronic receipt to the financial institution.

In some embodiments, the computer program product further comprises instructions configured to use a user output device to ask the consumer whether the consumer desires to have the electronic receipt electronically transmitted to the financial institution. In some embodiments, the third instructions comprise instructions configured to electronically transmit the electronic receipt to the financial institution. In some embodiments, the computer program product of claim 53, further comprises instructions configured to use a communication device to send a communication to a consumer computer system inquiring whether the consumer desires to have the electronic receipt electronically transmitted to the financial institution.

In some embodiments, the second instructions comprise instructions configured to receive consumer preferences from a memory device, wherein the consumer preferences comprise the consumer's preferences regarding transmission of electronic receipts. In some embodiments, the third instructions comprise instructions configured to request that the vendor transmit the electronic receipt to the financial institution. In some embodiments, the third instructions comprise instructions configured to communicate an electronic indication to the financial institution that the consumer desires to have the electronic receipt electronically transmitted to the financial institution. In some embodiments of the invention, the financial institution comprises a bank, and wherein the bank maintains a financial account used by the consumer during the transaction.

### BRIEF DESCRIPTION OF THE DRAWINGS

Having thus described embodiments of the invention in general terms, reference will now be made to the accompanying drawings:

FIG. 1 illustrates an electronic receipt collection and management system in accordance with an embodiment of the invention;

FIG. 2 is a flow chart illustrating an exemplary method of collecting and managing electronic receipts, in accordance with an embodiment of the invention;

FIG. 3 is a flow chart illustrating an exemplary method of determining whether a consumer wishes to have an electronic receipt collected, according to an embodiment of the invention;

FIG. 4 is a flow chart illustrating an exemplary method according to which a financial institution collects electronic receipts arising out of transactions involving a financial account with the financial institution, in accordance with an embodiment of the invention; and

FIG. 5 is a flow chart illustrating an exemplary method according to which a financial institution collects electronic receipts arising out of purchases made using vendor accounts, in accordance with an embodiment of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the present invention concern the collection of a consumer's detailed receipt information in electronic form (“electronic receipts”) and storage of the electronic receipts in an “e-receipts account” accessible to the consumer online. In some embodiments, this e-receipts account may be managed by a banking institution already managing at least one financial account of the consumer, for example, a checking account, also referred to as a demand deposit account or, more generally, a deposit account. Indeed, in some cases, the e-receipts account may be incorporated into the online banking services already provided by the bank to the consumer.

In general, according to some embodiments of the present invention, a consumer first makes a purchase from a vendor. During the course of the purchase, it is determined that an electronic receipt should be sent to the consumer's bank. This could happen in a number of different ways. First, the vendor may simply inquire if the consumer would like an electronic receipt, in which case the consumer could respond in the affirmative and provide the vendor with the bank information. This may be somewhat inefficient as it holds both the vendor and the consumer at the point-of-sale while they sort out the details. In other embodiments, the consumer has an account with the vendor (such as a preferred buyer account, online account or the like). In such embodiments, the consumer's preference for electronic receipts and the relevant bank information is stored in the consumer's account. Therefore, each time the consumer makes a purchase with the vendor using the account, an electronic receipt is automatically sent to the consumer's bank of choice. In other embodiments, rather than informing the vendor of her preference for electronic receipts, the consumer may inform the issuer of her credit card, debit card, or other instrument of payment (i.e., payment device). Therefore, each time the consumer makes a purchase using that instrument, the issuing entity submits a request to the vendor that the vendor send an electronic receipt to the consumer's bank of choice. Where the consumer's bank of choice happens to be the issuing entity, the communication of the request may be incorporated seamlessly into the processing of the payment.

In accordance with some embodiments of the present invention, the consumer's bank, upon receiving the electronic receipt from the vendor, stores the electronic receipt in the e-receipts account for the consumer. As mentioned above, the consumer may then be able to review and manage her electronic receipts through the bank's online banking service. Thus, in some embodiments, the consumer has an online repository for her receipts that she can access whenever she chooses and organize in any way she chooses. The consumer may print or transmit copies of the electronic receipts from the e-receipts account for merchandise returns, warranty claims, reimbursement claims, tax filings, or any other reason. The consumer may use the stored electronic receipts to track her budget, review her account statements for fraudulent use, or keep tabs on the spending of family members. Where the consumer is a business, the business may use the electronic receipts to manage the expenses of the business and the spending of employees. The advantages and opportunities to increase efficiency and value presented by embodiments of the present invention are countless. Indeed, embodiments of the present invention not only spare the consumer the hassle of shuffling through piles of old receipts, but also benefit the environment by reducing the paper used to print receipts.

As will be appreciated by one of skill in the art in view of this disclosure, the present invention may be embodied as a method, apparatus (system, device, computer program product, etc.), or a combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or medium. More specific examples of the computer readable medium include, but are not limited to, a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods and apparatuses (systems, computer program products, etc.). It will be understood that each block of the flowchart illustrations and/or block diagrams, and/or combinations of blocks in the flowchart illustrations and/or block diagrams, can be implemented by computer program instructions. These computer program instructions may be provided to a processing device of a general purpose computer, special purpose computer, or other programmable data processing apparatus to produce a particular machine, such that the instructions, which execute via the processing device of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions that implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

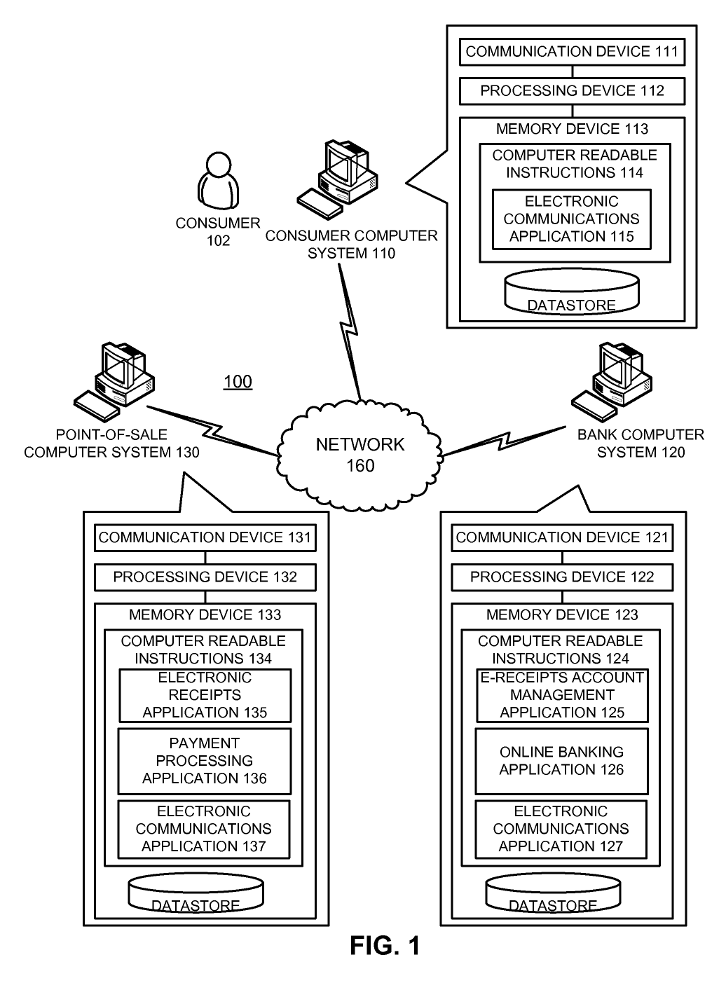

FIG. 1 illustrates an exemplary electronic receipts collection and management system 100 in accordance with an embodiment of the present invention. As shown in FIG. 1, in one embodiment, the electronic receipts collection and management system 100 includes a consumer computer system 110, a point-of-sale (“POS”) computer system 130, and a bank computer system 120. Although, for simplicity, FIG. 1 only illustrates one of each computer system, it will be appreciated that, in some embodiments of the invention, there will be many consumer computer systems 110, many POS computer systems 120, and/or many bank computer systems 120. Furthermore, although the term “bank” is used herein to describe some embodiments of the invention, other embodiments of the invention many involve other financial institutions in addition to or as an alternative to a bank. As used herein and in the claims, the term “financial institution” refers to an institution that acts as an agent to provide financial services for its clients or members by processing financial transactions for its clients or members. Financial institutions can include, but are not limited to, banks, building societies, credit unions, stock brokerages, asset management firms, savings and loans, money lending companies, insurance brokerages, insurance underwriters, dealers in securities, and similar businesses. Retail, wholesale, and service businesses, as well as manufacturers, may also process financial transactions and/or maintain accounts for consumers as disclosed herein. As such, the bank computer system 120 of FIG. 1 could be the computer system of another financial institution involved in banking or other financial transactions, but not traditionally thought of as a bank.

Referring again to the embodiment illustrated in FIG. 1, the consumer computer system 110, and the point-of-sale (“POS”) computer system 130 are operatively coupled, via a network 160, to the bank computer system 120. The network 160 may be a global area network (GAN), such as the Internet, a wide area network (WAN), a local area network (LAN), or any other type of network or combination of networks. The network 160 may provide for wireline, wireless, or a combination of wireline and wireless communication between devices in the network. In one embodiment, the network is a secure network. It will be understood that, when two components are described herein as communicating over a network, the components may be directly coupled to each other or indirectly coupled via one or more other components. Furthermore, although at least some of the systems described herein are described as having several unique components, these components need not be separate and distinct from one another, and two or more of such components may, in some embodiments, be combined into a single component that performs all of the functions of the multiple components so combined as described herein.

As illustrated in FIG. 1, the consumer computer system 110 generally comprises a communication device 111, a processing device 112, and a memory device 113. The processing device 112 is operatively coupled to the communication device 111 and the memory device 113. The processing device 112 uses the communication device 111 to communicate with the bank computer system 130 over the network 160. The processing device 112 also uses the communication device 111 to communicate with the consumer 102. As such, the communication device 111 generally comprises a modem, server, wireless card, radio, and/or other device for communicating with other devices on the network 160, and a display, mouse, keyboard, microphone, touch pad, touch screen, speaker, and/or other device for communicating with the consumer 102. The consumer 102 may be an individual, a business, or any other entity that may make purchases or hold financial accounts.

As used herein and in the claims, the term “processing device” generally refers to circuitry used for implementing communication and/or logic functions of the system in which it resides. A processing device may include, for example, a digital signal processor device, a microprocessor device, and various analog-to-digital converters, digital-to-analog converters, and other support circuits. Control and signal processing functions of a system are allocated between these processing devices according to their respective capabilities. The processing device may also include functionality to operate one or more computer applications based on computer-readable instructions (i.e., computer program code) thereof, which may be stored in a memory device in communication therewith. As used herein and in the claims, the term “memory device” generally refers to any device having computer-readable medium configured to store, for example, data and/or one or more computer applications.

As further illustrated in FIG. 1, the consumer computer system 110 includes computer-readable instructions 114 stored in the memory device 113, which include the computer-readable instructions 114 of an electronic communications application 115. The electronic communications application 115 includes computer program code that, when executed by the processing device 112, allows the consumer 102 to receive, store, and transmit electronic messages utilizing the communication device 111. For example, in one embodiment of the present invention, the electronic communications application 115 may include a short message service (SMS) text messaging application or an email application.

In one embodiment, the consumer computer system 110 is a consumer's desktop computer. In other embodiments, however, the consumer computer system 110 is a consumer's mobile computing device, which may include, for example, a mobile telephone, a personal digital assistant, a mobile picture taking device, a laptop computer, a mobile email device, a mobile texting device, a mobile music device, and/or any other mobile terminal.

As illustrated in FIG. 1, the bank computer system 120 generally includes a communication device 121, a processing device 122, and a memory device 123. The processing device 122 is operatively coupled to the communication device 121 and the memory device 123. The processing device 122 uses the communication device 121 to communicate with the consumer computer system 110 and the POS computer system 130 over the network 160. As such, the communication device 121 generally comprises a modem, server, wireless card, radio or other device for communicating with other devices on the network 160.

As further illustrated in FIG. 1, the bank computer system 120 includes computer-readable instructions 124 stored in the memory device 123, which include the computer-readable instructions 124 of an e-receipts account management application 125, an online banking platform 126, and an electronic communications application 127. The e-receipts account management application 125 includes computer program code that, when executed by the processing device 122, performs functions such as storing, organizing, and otherwise managing the electronic receipts belonging to the consumer 102. The online banking platform 126 is an interactive web-based solution that may be accessed by account holders, including the consumer 102, to view their various accounts, including an e-receipts account, and perform account management tasks. Finally, the electronic communications application 127 includes computer program code for receiving, storing, and transmitting electronic messages utilizing the communication device 121. In some embodiments, the bank computer system 120 is operated by or on behalf of a banking institution that maintains one or more financial accounts for the consumer 102 (hereinafter referred to as the “bank”). Although FIG. 1 illustrates the bank computer system 120 as one system, it is important to note that there can be one or multiple systems, each with similar components that handle the various functions of the bank computer system 120.

The POS computer system 130 generally includes a communication device 131, a processing device 132, and a memory device 133. The processing device 132 is operatively coupled to the communication device 131 and the memory device 133. The processing device 132 uses the communication device 131 to communicate with the bank computer system 120 over the network 160. As such, the communication device 131 generally comprises a modem, server, or other device(s) for communicating with other devices on the network 160.

As further illustrated in FIG. 1, the POS computer system 130 contains computer-readable program instructions 134 stored in the memory device 133, including computer-readable instructions 134 of an electronic receipts application 135, a payment processing application 136, and an electronic communications application 137. The electronic receipts application 135 generally includes computer program code that, when executed by the processing device 132, generates and manages the transmission of electronic receipts. The payment processing application 136 generally includes computer program code that, when executed by the processing device 132, performs payment processing functions, for example, in the case of a debit card payment, reading the debit card, contacting the issuing entity, requesting authorization from the issuing entity, receiving authorization from the issuing entity, and receiving the payment. The electronic communications application 137 includes computer program code for receiving, storing, and transmitting electronic messages utilizing the communication device 131. Although FIG. 1 illustrates the POS computer system 130 as one system, it is important to note that there can be one or multiple systems, each with similar components that handle functions herein attributed to the POS computer system 130.

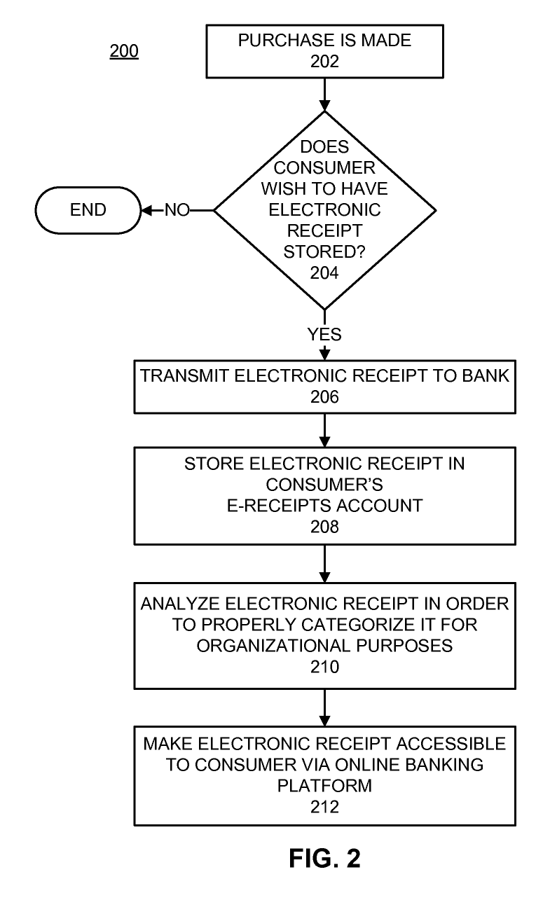

With reference now to FIG. 2, a flow chart illustrating an exemplary method 200 of collecting and managing electronic receipts in accordance with some embodiments of the invention is provided. As represented by block 202 in FIG. 2, the consumer 102 first makes a purchase that gives rise to a receipt. The purchase may be made in-store, online, via telephone, or otherwise. As used herein, the term “purchase” may not be a typical payment in exchange for goods or services, and should be construed to be any financial transaction that gives rise to a receipt. Indeed, as used herein, “purchase” may mean a charitable donation, a return of merchandise, or even a bank deposit. Thus, it should be clear that the term “purchase” does not limit the nature of financial transaction that may be the subject of embodiments of the present invention unless the context clearly indicates otherwise. As represented by block 204, and according to some embodiments, once the purchase has been initiated by the consumer 102, a determination is made as to whether the consumer 102 wants to save an electronic receipt corresponding to the purchase. This determination may be made in a number of different ways.

In some embodiments, the purchase may be made by the consumer 102 using a bank card associated with a financial account of the consumer 102 maintained by the bank. As used herein, the term “bank card” refers to a debit card, credit card, or any other payment device that is used by a consumer to effectuate a purchase. As used herein, the term “bank account” refers to a debit account (e.g., demand deposit account), credit account, or any other financial account used during a purchase. As used herein, the term “bank card” is not limited to cards issued by banks and, instead, also includes cards and other payment devices (e.g., a radio frequency identification tag) issued by other financial institutions or their agents.

In some embodiments, the consumer 102 may have informed the bank in advance that she wishes to have her electronic receipts automatically collected whenever possible. For example, the consumer 102 may state this preference when enrolling in an e-receipts service offered by the bank. In such embodiments, the bank, through the bank computer system 120, may request an electronic receipt from the POS computer system 130 during the communication that occurs during processing of the purchase.

The purchase is processed by the POS computer system 130 and the bank computer system 120 working in communication with one another. More specifically, the POS computer system 130 uses the communication device 131 and the payment processing application 136 to communicate to the bank computer system 120 information regarding the purchase, including the amount of money at issue and the origin and destination of that money, as well as information identifying the consumer 102 and/or the particular financial account belonging to the consumer 102 that is affected by the transaction. The POS computer system 130 may be any type of computer system used for processing purchases and may be operated by or on behalf of any entity or multiple entities. Furthermore, the POS computer system 130 may be located at the point-of-sale, or may be at a remote location. For example, if the consumer 102 purchases goods from a vendor using her debit card, the POS computer system 130 would generally include the computer system employed by the vendor to process the debit card payment, including, for example, the computer system of the checkout register and debit card terminal and the computer systems of the vendor's banking institution and any intermediary financial institution. The bank computer system 120 uses the information communicated from the POS computer system 130 to issue an authorization for the purchase and process the purchase within the bank, for example, by debiting or crediting the particular financial account of the consumer 102 affected by the purchase.

In addition to processing the purchase within the bank, in some embodiments the bank computer system 120 determines whether the consumer 102 has enrolled in an e-receipts service or otherwise engaged the bank to automatically collect electronic receipts for the consumer 102. This determination may be made by the bank computer system 120 prior to, concurrently with, or directly after authorization and processing of the purchase. The preference information for the consumer 102 would be stored in the memory device 123 of the bank computer system 120 in relation to the financial account of the consumer 102 so that the bank could locate the information whenever a purchase affecting that financial account is processed. In the event the bank computer system 120 determines that the consumer 102 has instructed the bank to collect electronic receipts, according to some embodiments, the bank computer system 120 transmits to the POS computer system 130 a request for an electronic receipt for the purchase. Such transmission may be made in conjunction with the transmission of authorization for the payment, or may be made separately.

In other embodiments, the bank may not automatically request an electronic receipt for every purchase. The bank or the consumer 102 may choose to require an affirmative request by the consumer 102 for electronic receipt collection for each purchase. For example, when enrolling in the e-receipts service, the consumer 102 may have stated a preference to have greater control over whether electronic receipts are collected by the bank. In such embodiments, the consumer 102 may have also provided a particular email address or phone number to which electronic communications from the bank regarding e-receipts should be sent. Again, this preference information would be stored in the memory device 123 of the bank computer system 120 in relation to the financial account of the consumer 102 so that the bank could locate the information whenever a purchase affecting that financial account is processed. In these embodiments, unlike those embodiments where the bank computer system 120 automatically requests an electronic receipt from the POS computer system 130, the bank computer system first seeks to obtain an affirmative request from the consumer 102 prior to requesting the electronic receipt. It may do so by transmitting an electronic message to the consumer 102 at the point-of-sale.

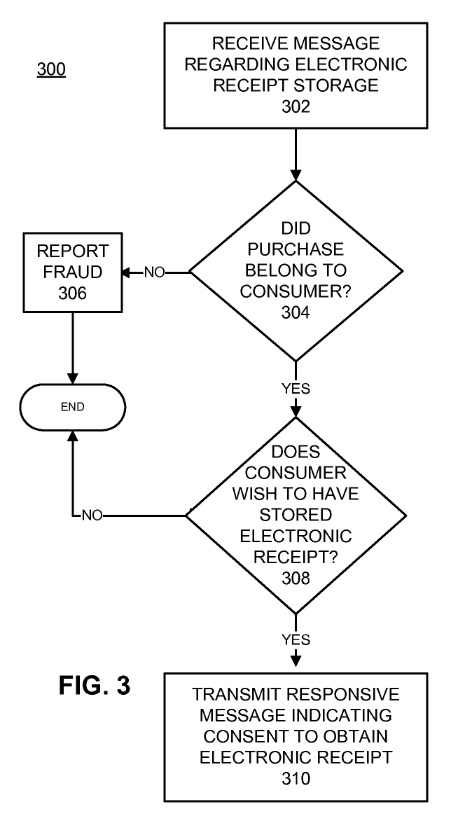

In this regard, FIG. 3 provides a flow chart illustrating an exemplary process for determining on a case-by-case basis whether the consumer 102 wants the bank to collect an electronic receipt, according to some embodiments of the present invention. As represented by block 302, the consumer 102 receives an electronic message from the bank. More particularly, the bank computer system 120, upon receiving the purchase information from the POS computer system 130 and identifying the financial account at issue, uses the communication device 121, the electronic communications application 126, and the preference information stored in the memory device 123 of the bank computer system 120 to transmit an electronic message to the consumer 102. The consumer 102 uses the communication device 111 of the consumer computer system 110 to view the message received from the bank computer system 120. In some embodiments, the content of the message transmitted to the consumer computer system 110 includes basic purchase information, such as, for example, the amount of the purchase and an identification of the vendor, as well as on offer to collect an electronic receipt if the consumer 102 takes a particular action, for example, responding to the message. This message may take the form of an SMS text message, an email, a voicemail, or other electronic message form. Where the POS computer system 130 and the bank computer system 120 are able to process the purchase in real-time or near-real-time, which is the case for many of the purchases that are the subject of embodiments of this invention, the consumer 102 may receive the electronic message at the point-of-sale.

In some embodiments and as represented by block 304, the consumer 102 will determine whether the transaction described in the message was initiated by her or a person authorized to make transactions involving her financial account with the bank. In the event that the transaction was not initiated by the consumer 102 or a person authorized by the consumer 102, according to some embodiments and as represented by block 306, the consumer 102 may contact the bank to report the unauthorized transaction. In one embodiment, the consumer 102 can use the consumer computer system 110 to reply to the message with a notification that the transaction was unauthorized.

On the other hand, in the event the consumer 102 does recognize the transaction as belonging to her or an authorized individual, the consumer 102 has the option of responding to the message to authorize the bank to obtain an electronic receipt, as shown in block 308. More specifically, the consumer 102 uses the communication device 111 of the consumer computer system 110 as well as the electronic communications application 127 to transmit a responsive message to the bank computer system 120. In some embodiments, the initial message from the bank computer system 120 will contain instructions on the responsive action that the consumer 102 must take in order to authorize collection by the bank of the electronic receipt. For example, the bank may ask that the consumer 102 reply to the message if she wishes to have an electronic receipt obtained, and ignore the message if she does not. Therefore, in such embodiments, the content of a responsive message by the consumer 102 may not be important, and, indeed, the responsive message may not include any content generated by the consumer 102 at all. It should be noted that if the consumer receives the message from the bank at the point-of-sale, the consumer 102 may also send the responsive message at the point-of-sale, such that all of these described communications are occurring in real-time or near real-time. Upon receipt of the responsive message from the consumer 102 indicating that the bank should obtain an electronic receipt, the bank computer system 120 communicates to the POS computer system 130 a request for an electronic receipt, just as it does in those embodiments where the request is automatic, as discussed above.

In still another embodiment, the bank computer system 120 and/or the POS computer system 130 are configured to use the POS computer system 130 to obtain the consumer's approval to transmit an electronic receipt to the bank computer system 130. For example, in one embodiment, the POS computer system 130 includes a transaction terminal, such as a bank card terminal, that uses its display or other user output device to ask the consumer 102 whether the consumer wishes to have an electronic receipt transmitted to the bank computer system 120. In such an embodiment, the consumer 102 can respond to the inquiry using the terminal's keypad, touch screen, touch pad, or other user input device. In some embodiments, the POS computer system 130 is configured to perform this inquiry any time a receipt is requested by the bank computer system 130 or anytime a transaction is made. In such embodiments, it may not be necessary to convey the consumer's answer to the inquiry to the bank computer system 120, since the POS computer system 130 may be able to respond accordingly on its own by, for example, sending an electronic receipt to the bank or other third party. In other embodiments, however, the bank computer system 120 uses the POS computer system 130 to communicate the inquiry to the consumer 102 and then waits for a consumer response before requesting an electronic receipt from the POS computer system 130.

Thus, it has been described that the bank computer system 120, upon receiving purchase information from the POS computer system 130 and processing the purchase on behalf of a consumer 102 having a financial account with the bank, checks predetermined preference information associated with the consumer 102 and either automatically requests an electronic receipt from the POS computer system 130 or contacts the consumer 102 for approval prior to requesting an electronic receipt. It should be understood, however, that according to other embodiments, the bank may not require that the consumer 102 opt-in by stating a preference to obtain electronic receipts. In such embodiments, the bank computer system 120 may not rely on the preferences of the consumer 102 and instead automatically request the electronic receipt from the POS computer system 130 or automatically contact the consumer 102 regarding obtaining an electronic receipt. In such embodiments, the bank may give the consumer 102 the ability to opt-out of the service.

On the other hand, and according to other embodiments, the consumer 102 may provide more detailed preference information, so that the bank computer system 120 takes a particular action depending on the particular purchase made. For example, the consumer 120 may choose to have the bank automatically obtain electronic receipts corresponding to purchases made from specific vendors, or a particular type of vendors (i.e. grocery stores), but still require case-by-case approval for electronic receipts for all other purchases.

Alternatively, and in accordance with other embodiments, the bank computer system 120 does not make a determination as to whether the consumer 102 wants an electronic receipt obtained, nor does it request an electronic receipt from the POS computer system 130. Rather, the POS computer system 130 automatically transmits an electronic receipt to the bank computer system 120. In some embodiments, this transmission occurs immediately after the POS computer system 130 receives a communication from the bank computer system 120 indicating that the purchase has been authorized and/or processed by the bank, although it could also occur in conjunction with the initial transmission to the bank computer system 120 concerning the purchase, such as with the authorization request.

The foregoing discussion of embodiments of the present invention was based on a stipulation that the purchase is made by the consumer 102 using a bank card associated with a financial account managed by the bank. In such instances, the bank is both the manager of the consumer's e-receipts account, and the manager of the consumer's underlying financial account that is affected by the purchase. This is advantageous because transmission of the electronic receipt by the POS computer system 130 to the bank computer system 120 can be simply an ancillary transmission to an already-established communication between the two systems (for purchase processing purposes). However, in situations where the purchase is made using a payment method other than a bank card associated with a financial account managed by the bank, the bank may still collect an electronic receipt for the purchase in accordance with embodiments of the present invention.

In that regard, there are multiple ways in which the determination may be made that the consumer wishes to have an electronic receipt collected by the bank, even when the bank is not one of the entities processing the purchase. For example, and according to some embodiments, the consumer 102 may state her preference for collection of electronic receipts to either the financial institution managing the financial account affected by the purchase (hereinafter referred to as the “third-party bank”). The preference of the consumer 102 may be made in advance, or, alternatively, at the point-of-sale. In some embodiments, the preference information provided by the consumer 102 to the third-party bank generally includes a request that the third-party bank collect electronic receipts to be transmitted to the bank, as well as details regarding the destination at the bank to which the electronic receipts should be sent, for example, an email address. This preference information is stored by the third-party bank in connection with the financial account of the consumer 102 such that it may be retrieved when a purchase affecting the financial account is made.

In some embodiments, the third-party bank performs essentially the same functions that were ascribed to the bank in those embodiments where the bank was directly involved in the purchase, except that the third-party bank collects the electronic receipt on behalf of the bank, rather than for itself. In particular, the third-party bank, while processing the purchase, communicates to the POS computer system 130 a request for an electronic receipt. In different embodiments, the third-party bank may request that the POS computer system 130 transmit the electronic receipt directly to the bank (in which case it would transmit to the POS computer system 130 the destination information supplied by the consumer 102) or it may actually receive the electronic receipt from the POS computer system 130 and retransmit it to the bank. Alternatively, and in accordance with other embodiments, the third-party bank may first obtain an affirmative consent from the consumer 102 to obtain the electronic receipt prior to issuing a request to the POS computer system 130 for the electronic receipt (as discussed in detail above with regard to the bank) or it may receive an electronic receipt from the POS computer system 130 without first transmitting a request.

Rather than providing preference information for electronic receipts to the third-party bank, according to some embodiments, the consumer 102 may provide such preference information directly to the vendor. In some embodiments, the consumer 102 may have an account with the vendor, such as a frequent buyer account, or an online account with the vendor for purchases on the vendor's website. The preference information of the consumer 102 may then be stored in connection with the account of the consumer 102 with the vendor such that it is retrieved when the consumer 102 makes a purchase from the vendor. At the point-of-sale, according to some embodiments, the POS computer system 120 processes the purchase, determines that the consumer 102 has a preference stored in her account for electronic receipts, and then transmits an electronic receipt to the bank using the communication device 121 and the destination information provided by the consumer 102. Alternatively, the consumer may request at the point-of-sale that an electronic receipt be transmitted to the bank. This request could be in response to a prompt by the vendor, or it could be initiated entirely by the consumer 102.

In the just-described embodiments, because the vendor, rather than the bank or a third-party bank, makes the determination as to whether the consumer 102 wants an electronic receipt transmitted to the bank, electronic receipts relating to cash purchases may be transmitted by the POS computer system 120 to the bank. In other embodiments that rely on the bank or a third-party bank to initiate collection of the electronic receipt, receipts relating to cash purchases would not be captured. Therefore, it is an advantageous aspect of some of the foregoing embodiments that receipts from cash purchases may be collected.

It should also be understood that, although it has been described that the consumer 102 would be responsible for stating her preferences for electronic receipts to either the vendor or the third-party bank, it is possible that the bank could take on this duty. For example, in some embodiments, the consumer 102 could notify the bank of particular vendors and third-party banks with which the consumer 102 has accounts, and perhaps provide detailed account information. The bank could communicate to those vendors and third-party banks a request that they transmit electronic receipts to the bank each time the consumer 102 makes a purchase using her account. The foregoing example is for illustrative purposes and should not be construed to limit the scope of embodiments of the present invention; there are many ways in which the bank could communicate a request for electronic receipts to a vendor or third-party bank even when an account managed by the bank is not affected by the purchase.

Thus, whether at the request of the bank, the consumer 102, or a third-party bank, according to some embodiments and as represented by block 206 of FIG. 2, an electronic receipt corresponding to the purchase is transmitted by the POS computer system 130 to the bank computer system 120. In other embodiments, and as described above, the electronic receipt may be first transmitted to a third-party bank and then later transmitted from the third-party bank to the bank computer system 130. In still other embodiments, the consumer 102 may personally transmit the electronic receipt to the bank computer system using the electronic communications application 115 and the communication device 111 of the consumer computer system 110. In such embodiments, the consumer 102 may have stated her preference with the vendor or the third-party bank that electronic receipts be sent to the consumer 102 rather than the bank. Instead of providing destination information at the bank (corresponding to the e-receipts account of the consumer 102), the consumer 102 may provide a personal email address. Alternatively, the consumer 102 may generate her own electronic receipt either by scanning the paper receipt or by transcribing the information appearing on the paper receipt in electronic format. In such instances, and according to different embodiments, the consumer may use the electronic communications application 115 or may log on to the bank's online banking platform 126, using the communication device 111 of the consumer computer system, to submit the generated electronic receipt to the bank. In any of the foregoing instances, the consumer 102 transmits the electronic receipt to the bank computer system 120 for storage in her e-receipts account.

Therefore, according to some embodiments, the bank computer system 120 receives, via the communication device 121, the electronic receipt that has been transmitted by the vendor (the POS computer system 130), the third-party bank, or the consumer 102. According to block 208, the bank then stores the incoming electronic receipt in the e-receipts account of the consumer 102 who made the purchase. More specifically, the bank computer system 120, utilizing the e-receipts account management application 125 as well as, in certain embodiments, the electronic communications application 127, identifies the consumer 102 and the e-receipts account to which the electronic receipt belongs, and stores the electronic receipt in that account. In embodiments where the bank has processed the purchase, for example where the consumer 102 used a bank card associated with a financial account managed by the bank, the bank has already identified the consumer 102 and a financial account belonging to the consumer 102, and may therefore ascertain the e-receipts account by using that information. As discussed further below, in some embodiments, the e-receipts account of the consumer 102 is related to the financial account(s) of the consumer 102 that are managed by the bank.

On the other hand, in embodiments where the bank has not been involved in processing the purchase, in order to properly store the electronic receipt in the e-receipts account of the consumer 102, the bank may rely either on the destination to which the electronic receipt was transmitted or on identifying information contained within or attached to the electronic receipt. For example, in some embodiments, the bank computer system 120 may associate a particular defined destination for incoming electronic transmissions (i.e. an email address, telephone number, IP address, etc.) within the bank computer system 120 with a particular consumer 102 or an account of the consumer 120, for example the e-receipts account. In such embodiments, any electronic receipts transmitted to that destination are automatically stored by the bank computer system 120 in the associated e-receipts account. Alternatively, in other embodiments, multiple e-receipts accounts may correspond to a single destination for incoming electronic transmissions within the bank computer system 120. In some embodiments, the bank computer system 120, utilizing the e-receipts account management application 125, is configured to read either the electronic receipt itself, or metadata transmitted in connection with the electronic receipt, and locate data identifying the consumer 102 or an account of the consumer 102 with the bank. This allows the e-receipts account management application 125 to properly store the electronic receipt in the e-receipts account belonging to the consumer 102 who made the purchase.

According to embodiments of the present invention, the electronic receipts transmitted to the bank computer system 120 and stored in the e-receipts account of the consumer 102 should be organized within the e-receipts account using a particular methodology. Indeed, in accordance with some embodiments, and as shown in block 210, an incoming electronic receipt is analyzed and categorized by the bank computer system 120 so that it may ultimately be stored in such a way to optimize ease of retrieval by the consumer 102. It should be understood that the analysis and categorization of the electronic receipt does not necessarily follow an initial storage of the electronic receipt in the e-receipts account, and may in fact occur prior to or concurrently with the storing of the electronic receipt in the e-receipts account by the bank computer system 120.

In some embodiments, the bank computer system 120, through the e-receipts account management application 125, reviews the electronic receipt to determine the time and date of the purchase, as well as information indicating the substance of the purchase. According to different embodiments, the e-receipts account management application 125 recognizes Merchant IDs, Uniform Product Codes, Stock-Keeping Unit codes, and/or the like within the electronic receipt or metadata attached to the electronic receipt and uses that data to categorize the purchase based on its substance. For example, purchases may be categorized as household, groceries, clothing, gas, restaurants, etc. Therefore, in some embodiments, the electronic receipts are organized within the e-receipts account according to the purchase type. Within each purchase type, the electronic receipts may be organized by date and time of purchase. Such organization of the electronic receipts within the e-receipts account advantageously allows the consumer 102 to easily keep track of her budget and quickly locate receipts for returns and other purposes.

According to some embodiments of the present invention, after an electronic receipt has been stored in the e-receipts account of the consumer 102, the bank computer system 120 makes the electronic receipt accessible to the consumer 102 through the online banking platform 126. In some embodiments, the consumer 102 may log on to the online banking platform 126 to manage her account(s), including her financial account(s) and/or her e-receipts account. In some embodiments, the consumer 102 uses the consumer computer system 110 to access the online banking platform 126, through which she may navigate to her e-receipts account. According to some embodiments, upon accessing her e-receipts account, the consumer 102 may view, print, edit, delete or add electronic receipts, create folders for electronic receipts, create electronic notes to be attached to particular electronic receipts (for example, reminders about the underlying purchases), and otherwise organize the electronic receipts stored in her e-receipts account. Indeed, the consumer 102 may, according to some embodiments, decide to create rules for the e-receipts account that alter the default organizational methodology utilized by the e-receipts account management application 125.

For example, the consumer 102 may instruct the e-receipts account management application 125 to group certain purchase types together, such as groceries and restaurants, and store all electronic receipts corresponding to those purchase types together. In other embodiments, the consumer 102 may decide that she does not want electronic receipts stored by purchase type at all, and instead instruct the e-receipts account management application 125 to simply store all electronic receipts by date and time of purchase. In still other embodiments, the consumer 102 may wish to organize the electronic receipts according to the bank card account used in the purchase. This may be especially useful where the consumer 102 has a specific bank card account that is used for business purchases, as the consumer 102 may want to use the receipts at a later date for tax or reimbursement purposes, or where the consumer 102 has multiple bank card accounts associated with different authorized users (for example, family members if the consumer 102 is an individual or employees if the consumer 102 is a business), as the consumer 102 may want to track the spending of individual authorized users. Indeed, the number of ways in which the consumer 102 may organize her e-receipts account is unlimited, and, according to embodiments of the present invention, the consumer 102 may undertake the task of organization by manually moving, copying, deleting, and editing electronic receipts, or the consumer may define rules for the e-receipts account management application 125 so that certain organizational tasks are automated.

In embodiments of the present invention where a purchase is made on behalf of a business, there are a number of different ways to handle the storage of the electronic receipt corresponding to the purchase. As mentioned above, the employee may have a specific bank card account associated with business purchases, and the employee may choose to have the electronic receipts from purchases made using that account transmitted and stored separately in her e-receipts account at the bank. From there, the electronic receipts may be automatically (through rules input by the employee) or manually transmitted to the accounts payable department of the business. Alternatively, according to some embodiments, the electronic receipts may be directly transmitted to the accounts payable department of the business from the vendor (the POS computer system 130) in addition to or instead of being transmitted to the employee's e-receipts account with the bank. In such embodiments, the destination information for the accounts payable department may be obtained by the vendor according to any of the methods by which the vendor obtains the destination e-receipts account information, i.e. by the employee stating a preference to the bank or the vendor that purchases made using that account be sent to the particular accounts payable destination. Indeed, electronic receipts relating to business purchases may be directly transmitted to the accounts payable department of the business even where a designated business account is not used, as long as the vendor is provided with destination information for the electronic receipt corresponding to the accounts payable department and instructed to transmit the electronic receipt to that destination. Thus, it has been described that, in some embodiments, the employee does not need to be responsible for maintaining receipts relating to business purchases, such as travel and living expenses, but instead those receipts may be directly submitted to the business's accounts payable department.

The foregoing embodiments may be typical in situations where the employee works for a company where business purchases must be paid by the employee and then reimbursed, rather than paid directly by the company, or in situations where the employee is self-employed. In such instances, the employee is still the consumer 102 for all purposes of the present invention. However, in other embodiments, the employee may have access to use a bank card or other financial account belonging to the company, and therefore the company is the consumer 102 for purposes of the present invention. In such embodiments, the electronic receipts corresponding to purchases made by the employee may be transmitted and stored in the e-receipts account of the company, rather than the employee. The accounting department of the company may organize the electronic receipts within the e-receipts account however it sees fit.

In some embodiments, the e-receipts account management application 125 has a feature allowing the consumer 102 to move or copy certain electronic receipts to an “e-receipts tax vault.” In such embodiments, the consumer 102 may decide that certain electronic receipts are relevant for tax purposes and elect to store these electronic receipts in a separate area designated for saving receipts to be used in preparing tax returns. This area is the e-receipts tax vault. Unlike a regular folder in the e-receipts account, according to some embodiments, the e-receipts tax vault stores electronic receipts for a period of at least seven years. Furthermore, in some embodiments, the e-receipts account management application 125 has a feature that allows the consumer 102 to either transmit the contents of the e-receipts tax vault to an accountant (perhaps subject to a date range constraint) or grant the accountant access to the e-receipts tax vault (but not the general e-receipts account of the consumer 102).

According to some embodiments of the present invention, the data stored in the e-receipts account may be shared with and/or accessed by other features and services of the online banking platform 126. For example, the online banking platform 126 may include a budgeting service where the consumer 102 has set up a budget. The electronic receipts stored in the e-receipts account and categorized by type of purchase could be shared with the budgeting service so that her actual expenditures in each category (evidenced by the electronic receipts) would be compared to her previously charted goals. This would advantageously allow the consumer 102 to track her progress on her budget without having to compare her budget to her financial account statements. In certain embodiments, the online banking platform 126 may communicate to the consumer 102 a notification (for example, by email) if the electronic receipts demonstrate that a particular aspect of the budget has been exceeded.

In other embodiments, the e-receipts account may share data with the online banking financial account statements. In this regard, electronic receipts in the e-receipts account could be related within the online banking platform 126 to entries in the financial account statements of the consumer 102. A single purchase by the consumer 102 may result in a debit to the checking account of the consumer 102 as well as the appearance of an electronic receipt in the e-receipts account of the consumer 102. In some embodiments, when the consumer views her online checking account statement through the online banking platform 126, she may see next to the entry for that purchase a hyperlink that allows the consumer 102 to access or retrieve the corresponding electronic receipt stored in her e-receipts account. The foregoing examples are for illustrative purposes only, and should not be construed to limit in any manner the ways in which the e-receipts account, and the data stored therein, may be integrated with other features and services of the bank and the online banking platform 126. Indeed, it should be appreciated that there are countless ways in which the e-receipts account and the systems and methods of the present invention may be utilized to advantageously add value to other services and offerings of the bank.

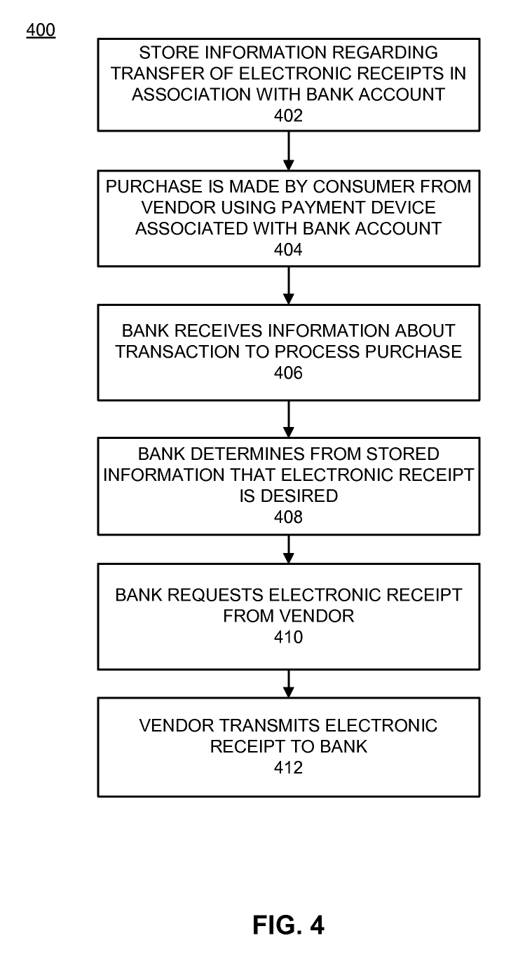

Many embodiments of the present invention have been described with reference to the flow chart of FIG. 2, and it has been demonstrated that the steps set forth therein may be effected by numerous distinct parties in numerous ways. Now, certain embodiments of the present invention will be discussed in greater detail for the purposes of example only. First, referring to FIG. 4, a flow chart is provided illustrating a method according to which the bank collects electronic receipts arising out of purchases made by the consumer 102 using a financial account with the bank. As represented by block 402, the bank first stores, in association with the consumer's financial account, information indicating that the consumer 102 would like electronic receipts collected. Next, as shown in block 404, the consumer 102 makes a purchase using a bank card tied to the financial account. As represented by block 406, during processing of the purchase, the bank receives information regarding the transaction, including information identifying the financial account. Once the bank has identified the financial account, the bank determines, as shown in block 408, that there is information stored in association with the financial account indicating that the consumer 102 would like electronic receipts collected. After this determination is made, as shown in block 410, the bank communicates a request to the vendor for an electronic receipt. Finally, as shown in block 412, the vendor transmits the electronic receipt to the bank, for storage in connection with the consumer's financial account. As discussed in greater detail previously, the request from the bank and the transmission by the vendor may be made in connection with other communications between the parties involving processing of the payment.

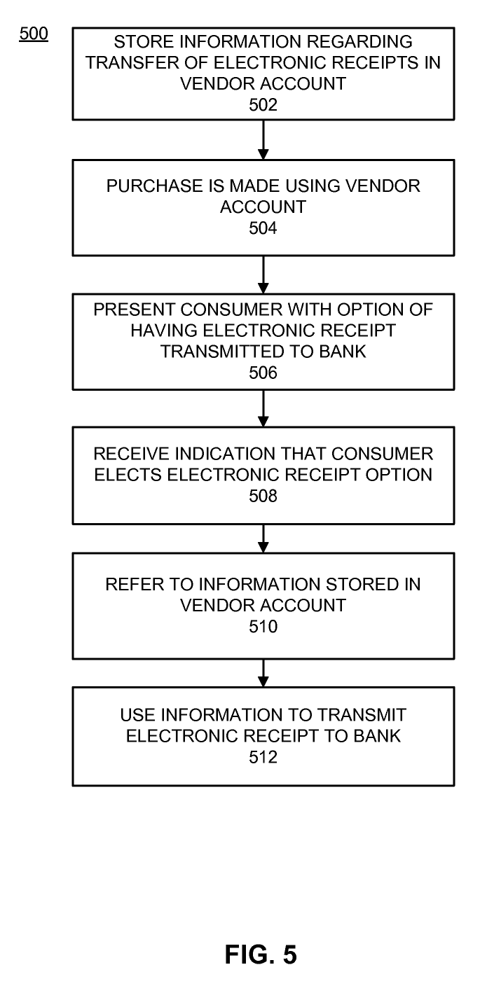

With reference now to FIG. 5, FIG. 5 provides a flow chart illustrating an exemplary method according to which the bank collects electronic receipts arising out of purchases made by the consumer 102 using vendor accounts, such as preferred buyer accounts or online accounts. As shown in block 502, the vendor stores information regarding electronic receipts in the consumer's vendor account, including information regarding how the electronic receipts should be transmitted to the consumer's bank. As discussed previously, this information may have been originally supplied by the consumer 102 or the bank. According to block 504, the consumer makes a purchase using its vendor account. Then, as represented by block 506, the vendor presents the consumer 102 with the option of transmitting an electronic receipt to the consumer's bank. In different embodiments, this option may be presented on a terminal that the consumer 102 is using to pay, or it may be presented in a webpage appearing during checkout for an online purchase, or it may even be presented orally by a cashier handling the purchase. Regardless of whether one of the foregoing methods is used, or another method for presenting the option, the consumer 102, according to block 508, indicates to the vendor that she would like an electronic receipt transmitted to her bank. At this point, as represented by block 510, the vendor refers to the stored information in the consumer's vendor account regarding how to transmit the electronic receipt to the bank, and, according to block 512, uses that stored information to transmit the electronic receipt to the bank for storage. The foregoing embodiments have been described for the purposes of example only and do not limit the ways in which collection of electronic receipts may occur in accordance with the present invention.

As used herein and in the claims, where it is said that a certain action is performed by a particular party, such a statement is intended to include situations where the certain action is performed by an agent of the particular party, unless the context of the statement clearly indicates otherwise. As used herein and in the claims, where it is said that a first party sends or receives something to or from a second party, such a statement is intended to include both situations where the first party sends or receives something directly to or from the second party and situations where the first party sends or receives something indirectly to or from the second party through on or more other intermediary parties.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus comprising:
a memory device comprising information about a bank account stored therein; and
a communication device configured to receive an electronic receipt associated with the bank account, wherein the electronic receipt results from a transaction, and wherein the communication device is configured to receive the electronic receipt from a party involved in the transaction; and
a processing device configured to store the electronic receipt in the memory device and associate the electronic receipt in the memory device with the bank account.

2. The apparatus of claim 1, wherein the information about the bank account comprises information regarding whether a person associated with the bank account desires for vendors to send electronic receipts to the apparatus.

3. The apparatus of claim 1, wherein the transaction involves the purchase of a product from a vendor, and wherein the party involved in the transaction comprises the vendor.

4. The apparatus of claim 1, wherein the transaction involves a consumer making a transaction with a vendor, and wherein the processing device is configured to use the communication device to request that the vendor receive permission from the consumer to send the electronic receipt to the apparatus.

5. The apparatus of claim 1, wherein the transaction involves a consumer, and wherein the processing device is configured to use the communication device to receive permission from the consumer to request the electronic receipt from the party involved in the transaction.

6. The apparatus of claim 1, wherein the transaction involves a consumer, and wherein the processing device is configured to use the communication device to send a request to a consumer computing device inquiring whether the consumer desires for the apparatus to store the electronic receipt in the memory device.

7. The apparatus of claim 6, wherein the processing device is configured to receive an indication from the consumer computing device that the transaction is fraudulent.

8. The apparatus of claim 6, wherein the information about the bank account includes information about how to contact the consumer computing device.

9. The apparatus of claim 1, wherein the memory device comprises a plurality of electronic receipts stored therein and associated with the bank account, wherein the processing device is configured to use the communication device to communicate information about the plurality of electronic receipts to a user, and wherein the processing device is configured to organize the plurality of receipts by vendor, vendor type, date, product type, or transaction amount.

10. The apparatus of claim 1, wherein the processing device is configured to allow a user to mark the electronic receipt as tax-related, and wherein the processing device is configured to store a tax-related electronic receipt for a predetermined length of time.

11. The apparatus of claim 1, wherein the memory device comprises a plurality of electronic receipts stored therein, and wherein the processing device is configured to allow the consumer to grant another party limited access to the plurality of electronic receipts.

12. An apparatus configured for use with a transaction between a vendor and a consumer, the apparatus comprising:
a user input device configured to receive an indication from the consumer that the consumer desires an electronic receipt resulting from the transaction be sent to a third party, wherein the third party is a party other than the vendor and the consumer; and
a processing device operatively coupled to the user input device and configured to permit a transfer of the electronic receipt from the vendor to the third party based at least partially on the indication received from the consumer.

13. The apparatus of claim 12, further comprising:
a user output device, wherein the processing device is operatively coupled to the user output device and configured to use the user output device to ask the consumer whether the consumer desires for the electronic receipt to be sent to a third party.

14. The apparatus of claim 13, wherein the user output device comprises a display, and wherein the processing device is configured to use the display to ask the consumer to decide between receiving a paper receipt and having the electronic receipt sent to the third party.

15. The apparatus of claim 12, wherein the user input device is located at the transaction's point-of-sale.

16. The apparatus of claim 15, wherein the user input device comprises a user interface of a point-of-sale terminal, and wherein the point-of-sale terminal is configured to obtain information from a payment device provided by the consumer.

17. The apparatus of claim 12, wherein the third party comprises a bank.

18. The apparatus of claim 17, wherein the transaction involves a consumer's payment device, and wherein the consumer's payment device is issued by the bank.

19. The apparatus of claim 12, wherein the transaction comprises a purchase made by the consumer on behalf of an employer of the consumer, and the third party comprises an accounts payable department of the employer.

20. The apparatus of claim 12, wherein the user input device is further configured to receive information regarding an account to use during the transaction.

21. The apparatus of claim 20, wherein the processing device is configured to permit a transfer of the electronic receipt from the vendor to a third party associated with the account.

22. The apparatus of claim 20, wherein the account comprises an account that the consumer has with the vendor.

23. The apparatus of claim 20, wherein the account comprises a bank account used during the transaction.

24. The apparatus of claim 12, wherein the user input device is configured to receive information from the consumer identifying the third party, and wherein the processing device is configured to send the electronic receipt to the third party based at least partially on the information received from the user input device.

25. The apparatus of claim 12, wherein the user input device comprises the user interface of a mobile phone.

26. The apparatus of claim 12, wherein the processing device is configured to receive information about the transaction from a bank involved in the transaction.

27. The apparatus of claim 12, wherein the processing device is configured to permit a transfer of an electronic receipt from the vendor to the third party by communicating the consumer's indication to the vendor or the third party.

28. The apparatus of claim 12, further comprising a memory device comprising the electronic receipt stored therein, wherein the processing device is configured to permit a transfer of an electronic receipt from the vendor to the third party by transferring the electronic receipt stored in the memory device to the third party.

29. An apparatus comprising:
a memory device comprising information about an account stored therein, wherein the account is associated with a consumer, and wherein the account comprises information regarding the transfer of electronic receipts associated with the account;
a communication device configured to receive information about a financial transaction involving the consumer; and
a processing device configured to transfer or request the transfer of an electronic receipt associated with the financial transaction based at least partially on the information stored in the memory device regarding the transfer of electronic receipts associated with the account.

30. The apparatus of claim 29, wherein the financial transaction involves a payment device associated with an issuing bank, and wherein the apparatus is maintained by the issuing bank.

31. The apparatus of claim 30, wherein the financial transaction involves a vendor, and wherein the processing device is configured to use the communication device to communicate a request to the vendor to transfer the electronic receipt.

32. The apparatus of claim 31, wherein the information regarding the transfer of electronic receipts comprises information regarding where the electronic receipt should be transferred, and wherein the request to the vendor includes a request for the vendor to transfer the electronic receipt to a location based on the information regarding where the electronic receipt should be transferred.

33. The apparatus of claim 32, wherein the location comprises a location of an entity other than the issuing bank.

34. The apparatus of claim 33, wherein the location comprises an accounts payable department of an employer of the consumer.

35. The apparatus of claim 29, wherein the financial transaction involves a vendor, and wherein the processing device is configured to use the communication device to communicate a request to the vendor to transfer the electronic receipt to the apparatus.

36. The apparatus of claim 35, wherein the processing device is configured to receive the electronic receipt from the vendor and use the communication device to transfer the electronic receipt to another entity based at least partially on the information stored in the memory device regarding the transfer of electronic receipts associated with the account.

37. The apparatus of claim 35, wherein the processing device is configured to receive the electronic receipt from the vendor, store the electronic receipt in the memory device, and associate the electronic receipt with the account.

38. The apparatus of claim 29, wherein the financial transaction involves a vendor, and wherein the apparatus is maintained by the vendor.

39. The apparatus of claim 29, wherein the financial transaction involves a vendor, and wherein the account comprises an account associated with the vendor.

40. The apparatus of claim 39, wherein the account comprises a preferred consumer account provided to the consumer by the vendor.

41. The apparatus of claim 29, wherein the information regarding the transfer of electronic receipts comprises information about whether the consumer desires to have the electronic receipt transferred.

42. The apparatus of claim 29, wherein the information regarding the transfer of electronic receipts comprises information regarding where the electronic receipt should be transferred.

43. A method implemented by a computerized apparatus configured to manage the transfer of a consumer's electronic receipts, the method comprising:
receiving an electronic indication of a transaction between a vendor and a consumer;
receiving an electronic indication from the consumer that the consumer desires to have an electronic receipt resulting from the transaction electronically transmitted to a financial institution; and
permitting electronic transmission of the electronic receipt to the financial institution.

44. The method of claim 43, wherein the computerized apparatus comprises a point-of-sale computer system.

45. The method of claim 44, further comprising:
using a user output device of the computerized apparatus to ask the consumer whether the consumer desires to have the electronic receipt electronically transmitted to the financial institution.

46. The method of claim 45, wherein permitting electronic transmission of the electronic receipt comprises electronically transmitting the electronic receipt to the financial institution.

47. The method of claim 43, wherein the computerized apparatus comprises a financial institution computer system.

48. The method of claim 47, further comprising:
using a communication device of the computerized apparatus to send a communication to a consumer computer system inquiring whether the consumer desires to have the electronic receipt electronically transmitted to the financial institution.

49. The method of claim 47, wherein receiving the electronic indication from the consumer that the consumer desires to have an electronic receipt resulting from the transaction electronically transmitted to the financial institution comprises:
receiving consumer preferences from a memory device, wherein the consumer preferences comprise the consumer's preferences regarding transmission of electronic receipts.

50. The method of claim 47, wherein permitting electronic transmission of the electronic receipt comprises requesting that the vendor transmit the electronic receipt to the financial institution computer system.

51. The method of claim 43, wherein the computerized apparatus comprises a consumer computer system.

52. The method of claim 51, wherein receiving the electronic indication of the transaction comprises receiving a communication from the financial institution.

53. The method of claim 51, wherein permitting electronic transmission of the electronic receipt comprises communicating an electronic indication to the financial institution that the consumer desires to have the electronic receipt electronically transmitted to the financial institution.

54. The method of claim 43, wherein the financial institution comprises a bank, and wherein the bank maintains a financial account used by the consumer during the transaction.

55. A computer program product configured to manage the transfer of a consumer's electronic receipts, the computer program product comprising a computer-readable medium having computer-readable program instructions stored therein, wherein the computer-readable program instructions comprise:
first instructions configured to receive an indication of a transaction between a vendor and a consumer;
second instructions configured to receive an indication from the consumer that the consumer desires to have an electronic receipt resulting from the transaction electronically transmitted to a financial institution; and
third instructions configured to permit electronic transmission of the electronic receipt to the financial institution.

56. The computer program product of claim 55, further comprising:
instructions configured to use a user output device to ask the consumer whether the consumer desires to have the electronic receipt electronically transmitted to the financial institution.

57. The computer program product of claim 55, wherein the third instructions comprise instructions configured to electronically transmit the electronic receipt to the financial institution.

58. The computer program product of claim 55, further comprising:
instructions configured to use a communication device to send a communication to a consumer computer system inquiring whether the consumer desires to have the electronic receipt electronically transmitted to the financial institution.

59. The computer program product of claim 55, wherein the second instructions comprise instructions configured to receive consumer preferences from a memory device, wherein the consumer preferences comprise the consumer's preferences regarding transmission of electronic receipts.

60. The computer program product of claim 55, wherein the third instructions comprise instructions configured to request that the vendor transmit the electronic receipt to the financial institution.

61. The computer program product of claim 55, wherein the third instructions comprise instructions configured to communicate an electronic indication to the financial institution that the consumer desires to have the electronic receipt electronically transmitted to the financial institution.

62. The computer program product of claim 55, wherein the financial institution comprises a bank, and wherein the bank maintains a financial account used by the consumer during the transaction.
